(19) United States
(12) Patent Application Publication
(10) Pub. No.: US 2026/0252521 A1
(43) Pub. Date: Aug. 27, 2026

(54) APPARATUS WITH LOOPBACK CONTROL MECHANISM AND METHODS FOR OPERATING THE SAME

(71) Applicant: Micron Technology, Inc., Boise, ID (US)

(72) Inventors: Sankalpa Hota, Bhubaneswar (IN); Arpan Kumar Joshi, Nuapada (IN); Pankaj Agrawal, Jaipur (IN); Animesh Jana, Medinipur (IN)

(21) Appl. No.: 19/451,661

(22) Filed: Jan. 16, 2026

Related U.S. Application Data
(60) Provisional application No. 63/762,511, filed on Feb. 24, 2025.

(51) Int. Cl. G06F 13/42; G06F 9/32

(52) U.S. Cl. CPC G06F 13/4234; G06F 9/321; G06F 2213/0026

(57) ABSTRACT

Methods, apparatuses and systems related to detecting and responding to a communicating counterpart device unintendedly and unilaterally entering a loopback failure state are disclosed. An apparatus configured to communicate with an external device may include a loopback control mechanism configured to monitor communication related parameters to detect that the external device has entered a loopback state without being commanded to do so. In response to detecting the unwanted loopback state, the apparatus may implement a response that includes one or more of logging the one or more parameters, flagging an error, and commanding the external device to exit the loopback state.

### CROSS-REFERENCE TO RELATED APPLICATIONS

The present application claims priority to U.S. Provisional Patent Application No. 63/762,511, filed February 24, 2025, the disclosure of which is incorporated herein by reference in its entirety.

### TECHNICAL FIELD

The disclosed embodiments relate to devices, and, in particular, to semiconductor memory devices with loopback control mechanisms and methods for operating the same.

### BACKGROUND

Electronic devices can employ electrical signals to communicate data. However, as technology advances, the demand for smaller, faster, and more capable devices is increasing at an unfathomable rate. However, shrinking the devices often introduces increased noise due to physical proximity between circuits. Increasing the capability of the device often requires increased power consumption, which leads to increase in the thermal energy that degrades communicated signals. Moreover, increasing the communication speed requires shorter durations to accurately transmit and capture each bit. Such challenges must be overcome in order to provide devices that meet the increasing demand.

### BRIEF DESCRIPTION OF THE DRAWINGS

The foregoing and other objects, features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure.

FIG. 1A is a block diagram of a computing system with communicating devices in accordance with an embodiment of the present technology.

FIG. 1B is a state diagram for an example loopback mechanism in accordance with an embodiment of the present technology.

FIG. 1C illustrates an example error condition in the communication between the devices of FIG. 1A.

FIG. 2 is a block diagram of a computing system in accordance with an embodiment of the present technology.

FIG. 3 is a flow diagram illustrating an example method of operating an apparatus in accordance with an embodiment of the present technology.

FIG. 4 is a schematic view of a system that includes an apparatus in accordance with an embodiment of the present technology.

### DETAILED DESCRIPTION

As described in greater detail below, the technology disclosed herein relates to an apparatus, such as memory systems, systems with memory devices, related methods, etc., for controlling or managing operational state of the apparatus. In managing the operational state, the apparatus can include a loopback control mechanism that prevents the apparatus from entering a failure loop, such as due to an erroneous communication.

As an illustrative example, a computing system can include a first device and a second device communicatively connected to each other through a link, such as a Peripheral Component Interconnect Express (PCIe) link. Accordingly, the PCIe link can correspond to a PCIe connection, and the first and second devices can communicate according to the PCIe protocol. In some embodiments, the first and second devices can include a host device communicating with a memory device (e.g., a solid-state drive (SSD)) through the PCIe link.

The computing system can have modes or functions that allow for a loop-based communication or exchange between the devices. For the PCIe example, the first and second devices can utilize a PCIe loopback mechanism configured to support a self-test and fault isolation for the corresponding computing system. The loopback mechanism can allow a receiving device to loop back or resend a data received from the sending device. Either the first device or the second device can initiate the loopback mechanism. The initiating device can correspond to the primary or the master device, and the other can correspond to the secondary or the slave device.

The loopback mechanism can have an entry condition and an exit condition. For the PCIe example, the entry condition can include the primary device setting a loopback indicator, such as a TS Loopback bit. In response to detecting the loopback indicator (e.g., the transition in the TS Loopback bit), the secondary device can send a trigger message set (e.g., the TS message set) to the primary device. The loopback mechanism can enter an active state when the primary device receives the trigger message set. In the active state, the primary device can send a valid data, and the secondary device can retransmit the valid data back to the primary device. Following the retransmission, the primary device can provide a command or an action that exits from or terminates the loopback mechanism. In some embodiments, the secondary device may be unable to initiate the exit and remain dependent on the primary device to terminate or exit out of the loopback mechanism.

Given the nature and/or the sequence of the loopback mechanism, the primary device and/or the secondary device may enter an error state that force the devices to remain in the loop condition. In other words, some error conditions may render the devices unable to detect an error condition and/or unable to exit from the loopback mechanism and the corresponding device failure (e.g., a system crash for the computing system).

Unfortunately, in conventional systems, erroneous signals may mimic the entry condition and cause the loopback failure, even when the loopback feature is disabled (e.g., when the device is in deployment mode). For example, signal integrity issues and signal noises can cause corrupt communicated signals/values that cause the secondary device (e.g., the host) to erroneously perceive the loopback entry condition (e.g., corrupted entry bit value and/or corrupted TS1 messages). As an illustrative example, the host device can receive corrupted set of TS messages with the loopback bit set. The host, as the secondary device, can subsequently return all received messages back to the memory device. Because the message had been corrupted, the host may perceive the memory device as the primary device, but the memory device would not be functioning as the primary device since it didn’t initiate the loopback process. Thus, the host will continue to echo the messages from the memory device until the host times out, thereby causing the system crash event.

To prevent such loopback error conditions, embodiments of the technology described herein can include a loopback control mechanism that can detect unintended loopback condition in the communicating device and force an exit from the loopback condition. The loopback control mechanism can include hardware, software, firmware, or a combination thereof configured to detect the communicating device unintendedly entering or initiating the loopback mechanism. In other words, the loopback control mechanism at one device can detect another/communicating device behaving as the secondary device when the signals for the entry condition have not been provided. The loopback control mechanism can detect that the communicating counterpart unintendedly entered the secondary device mode based on tracking a recovery count, a replay count, or a combination thereof.

The loopback control mechanism utilizing the recovery count and the replay count can provide the capability to detect and exit out of unexpected loopback conditions for the communicating counterpart. Thus, the loopback control mechanism can reduce related system crash events caused by signal integrity issues.

Moreover, the loopback control mechanism can log the counts and the corresponding detections, thereby allowing system designers and administrators to better identify signal integrity issues. Without the loopback control mechanism, conventional systems would lose the parameters/conditions due to the system crash event, thus leaving little or no indications/clues as to the cause of the system crash for the system designers and administrators.

Further, as communication speeds increase and corresponding signal/bit detection windows decrease, the signal integrity issues are more likely to cause errors within the narrowed windows. The loopback control mechanism can provide increased robustness in view of increasing communication speeds by detecting the effects of the corrupted signals and providing a way to exit out of the loopback failure progression.

### Loopback Mechanism

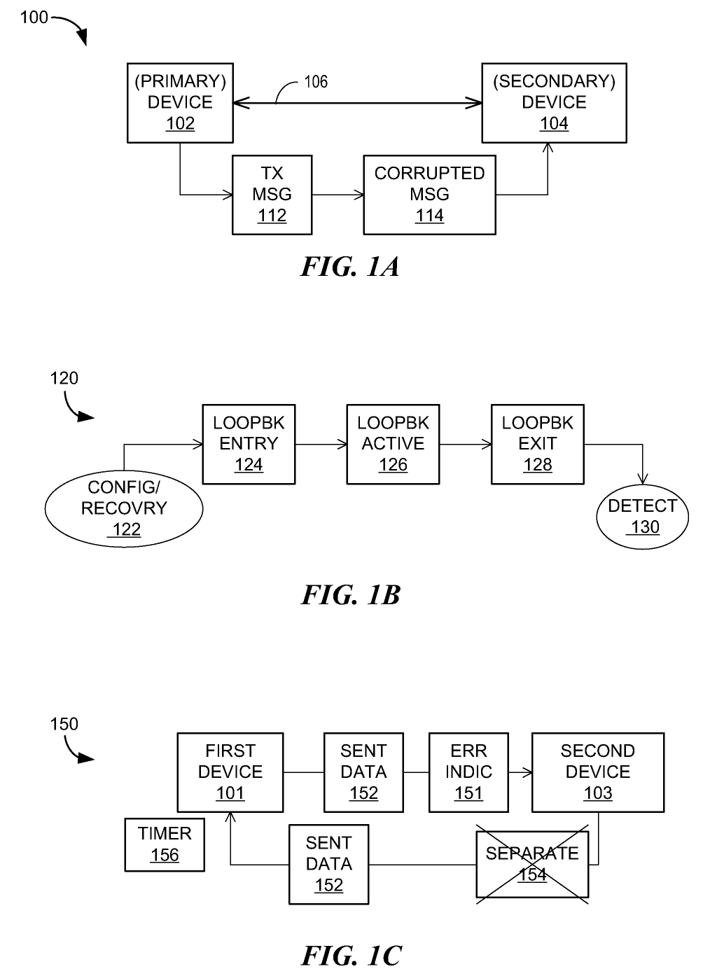

FIG. 1A is a block diagram of a computing system 100 with communicating devices 102 and 104 in accordance with an embodiment of the present technology. The computing system 100 can include a computer, such as a personal computer, a mainframe computer, a mobile computer (e.g., a notebook computer, a tablet computer, a smart phone, a wearable device, etc.), a server system, and the like. The communicating devices 102 and 104 of the computing system 100 can include a host device and a memory device (e.g., a SSD system).

The communicating devices 102 and 104 can be communicatively coupled/connected through a communication link 106, such as the PCIe link. The communication link 106 can include a wired or a wireless connection that provide the conduit for exchanging information between the communicating devices 102 and 104.

With respect to specific features associated with the communication link 106, the communicating devices 102 and 104 can assume a primary or master device role and a separate secondary or slave device role. For example, for the PCIe loopback mechanism (e.g., a predetermined self-test protocol for communicating known or repeated data values), the device initiating the mechanism can be deemed a primary device, and the other device can be a secondary device. For illustrative purposes, the device 102 is shown in FIG. 1A as the primary device (e.g., the memory device) initiating the loopback mechanism, and the device 104 is shown as the secondary device (e.g., the host device).

Unfortunately, communications between devices are susceptible to corruption, such as due to degradation or structural issues in the communication link 106, introduction of signal noise, timing errors, and/or other similar signal integrity issues. When a transmitting device sends a transmitted message 112, the signal integrity issue can cause the receiving device to receive a corrupted message 114 that differs from the transmitted message 112. Even with error correction features, the corrupted message 114 can include changes that prevent the receiving device to recover the initially transmitted message 112.

The corrupted message 114 can cause various issues during the operation of the computing system 100. While some of the issues may be relatively less severe, other issues may have greater negative impact on the operation of the computing system 100. The greater negative impact can include a system crash event that renders the computing system 100 unable to continue operating. For example, when the communication link 106 is a PCIe link, the communicating devices 102 and 104 can implement a loopback mechanism configured to resend received information for self-testing purposes. However, when the transmitted message 112 is corrupted through signal instability, the corrupted message 114 may falsely trigger the receiving device to enter the loopback mechanism as the secondary device 104. However, since the transmitting device did not intend to initiate the loopback mechanism, the entry into the loopback mechanism may be limited to the receiving device. Such one-sided change in the device state can stop all functional communications and cause the system crash event.

For context, FIG. 1B is a state diagram for an example loopback mechanism 120 in accordance with an embodiment of the present technology. Prior to entering or initiating the loopback mechanism, the communicating devices 102 and 104 of FIG. 1A can be operating in a different configuration or a recovery mode as shown in block 122. The communicating devices 102 and 104 of FIG. 1A can arrive at a loopback entry state 124 based on satisfying an entry condition. For example, the initiating device can assume the role of the primary device 102 can send a loopback indicator (e.g., by setting a TS loopback bit in a TS1 message).

From the loopback entry state 124, the computing system 100 of FIG. 1A can enter the loopback active state 126 when the primary device 102 receives an identical TS set from the secondary device 104. In other words, the device receiving the loopback indicator can assume the role of the secondary device 104 and send an identical TS set back to the primary device 102 to enter the loopback active state 126. Once in the loopback active state 126, the primary device 102 can send valid data to the secondary device 104, and the secondary device 104 can retransmit the received data back to the primary device 102.

After receiving the retransmitted data, the primary device 102 can perform an action and/or issue a command to transition out of the loopback active state 126 and to a loopback exit state 128. By entering the loopback exit state, the primary device 102 that initiated the loopback mechanism 120 can terminate the loopback mechanism 120. The secondary device 104 may be unable to exit out of or terminate the loopback mechanism 120 on its own.

To illustrate the failure scenario, FIG. 1C illustrates an example error condition in the communication between the devices of FIG. 1A. A first device 101 can send the transmitted message 112. However, signal integrity issues may cause the transmitted message 112 to deform or degrade during transmission through the communication link 106 of FIG. 1A and/or while receiving at a second device 103. When the degraded result unintentionally matches an erroneous indication 151 (e.g., bit pattern matching the loopback indicator described in FIG. 1B), the second device 103 can assume the role of the secondary device 104 of FIG. 1A and enter the loopback entry state 124 on its own.

However, since the first device 101 did not send the loopback indicator and did not intend to enter the loopback entry state 124, the first device 101 can function differently and not according to the loopback mechanism 120. Moreover, conventionally, the first device 101 may remain unaware that the second device 103 has initiated the loopback mechanism 120 and assumed the role of the secondary device 104. Thus, when the first device 101 sends a next sent data 152 (e.g., a response to a command from the host), the second device 103 can retransmit the next sent data 152 back to the first device 101. For example, the memory device in place of the first device 101 can provide the read data or a status to the host functioning as the secondary device 104, and instead of a separate message (e.g., a new command or a corresponding response), the host can echo the same read data back to the memory device.

The echoed transmission can be unexpected at the first device 101, thus causing an error condition that pauses normal operations at the second device 103 (e.g., due to being in the loopback entry state 124) and/or the first device 101 (e.g., due to the unexpected echo). Such error conditions and the pause in the normal operations can trigger a timer 156 that corresponds to the system crash event. When the timer 156 lapses, the computing system 100 can provide a system error message, such as an operating system failure/crash message or screen, and halt functionalities. The system crash may be cleared through a power-on reset condition that resets the hardware components of the computing system 100.

### Example Environment with Loopback Control

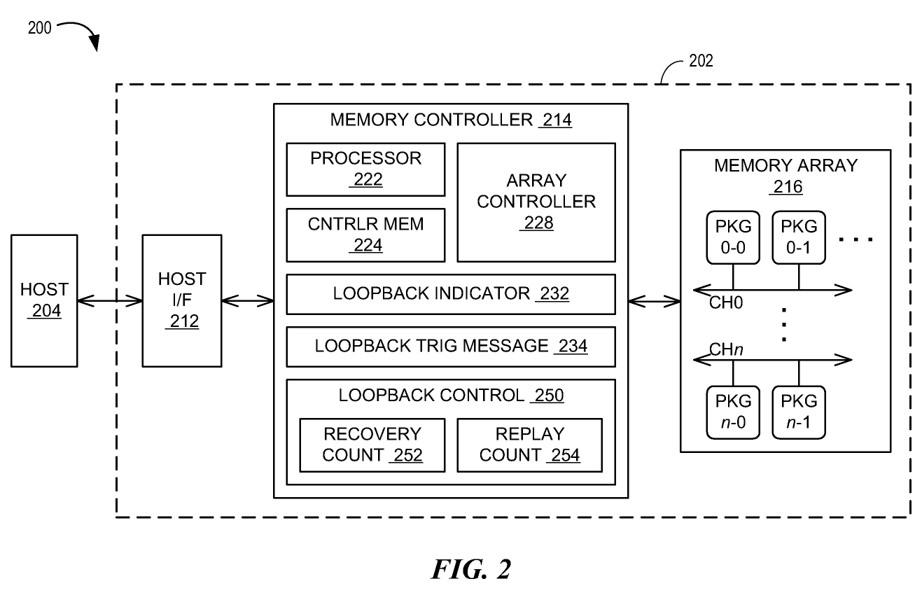

FIG. 2 is a block diagram of a computing system 200 in accordance with an embodiment of the present technology. The computing system 200 can include a personal computing device/system, a mobile device (e.g., a mobile/smart phone), a wearable device, an enterprise device, a server, a mainframe, or the like. The computing system 200 can include a memory system or subsystem 202 (e.g., a SSD) coupled to a host device 204. The host device 204 can include one or more processors or stand-alone computing devices that can write data to and/or read data from the memory system 202. For example, the host device 204 can include a central processing unit (CPU) controlling the operation of the computing system 200.

The memory system 202 can include circuitry configured to store data (via, e.g., write operations) and provide access to stored data (via, e.g., read operations). For example, the memory system 202 can include a persistent or non-volatile data storage system, such as a NAND-based Flash drive system or the like. In some embodiments, the memory system 202 can include a host interface 212 (e.g., buffers, transmitters, receivers, and/or the like) configured to facilitate communications with the host device 204. For example, the host interface 212 can be configured to support one or more host interconnect schemes, such as Universal Serial Bus (USB), Peripheral Component Interconnect (PCI), Serial AT Attachment (SATA), Universal Flash Storage (USF) protocol, or the like. The host interface 212 can receive commands, addresses, data (e.g., write data), and/or other information from the host device 204. The host interface 212 can also send data (e.g., read data) and/or other information to the host device 204.

The memory system 202 can further include a memory controller 214 and a memory array 216. The memory array 216 can include memory cells that are configured to store a unit of information. For example, the memory array 216 can include NAND dies or packages. The memory controller 214 can be configured to control the overall operation of the memory system 202, including the operations of the memory array 216.

In some embodiments, the memory array 216 can include a set of storage devices or packages. Each of the storage devices can include a set of memory cells that each store data in a charge storage structure. The memory cells can include, for example, floating gate, charge trap, phase change, ferroelectric, magnetoresistive, and/or other suitable storage elements configured to store data persistently or semi-persistently. The memory cells can be one-transistor memory cells that can be programmed to a target state to represent information. For instance, electric charge can be placed on, or removed from, the charge storage structure (e.g., the charge trap or the floating gate) of the memory cell to program the cell to a particular data state. The stored charge on the charge storage structure of the memory cell can indicate a Vt of the cell. For example, a SLC can be programmed to a targeted one of two different data states, which can be represented by the binary units 1 or 0. Also, some flash memory cells can be programmed to a targeted one of more than two data states. Multi-level cells (MLCs) may be programmed to any one of four data states (e.g., represented by the binary 00, 01, 10, 11) to store two bits of data. Similarly, triple-level cells (TLCs) may be programmed to one of eight (i.e., 2³) data states to store three bits of data, and quadruple-level cells (QLCs) may be programmed to one of 16 (i.e., 2⁴) data states to store four bits of data.

Such memory cells may be arranged in rows (e.g., each corresponding to a word line) and columns (e.g., each corresponding to a bit line). The arrangements can further correspond to different groupings for the memory cells. For example, the memory groupings can include memory pages arranged according to word line. Also, the memory groupings can include memory blocks. In operation, the data can be written or otherwise programmed (e.g., erased) with regards to the various memory regions of the memory array 216, such as by writing to groups of pages and/or memory blocks. In NAND-based memory, a write operation often includes programming the memory cells in selected memory pages with specific data values (e.g., a string of data bits having a value of either logic 0 or logic 1). An erase operation is similar to a write operation, except that the erase operation re-programs an entire memory block or multiple memory blocks to the same data state (e.g., logic 0).

As described above, the memory system controller 214 can be configured to control the operations of the memory array 216. The memory system controller 214 can include a processor 222, such as a special purpose logic circuitry (e.g., a field programmable gate array (FPGA), an application specific integrated circuit (ASIC), etc.), a microprocessor, or other suitable processor. The processor 222 can execute instructions encoded in hardware, firmware, and/or software (e.g., instructions stored in controller embedded memory 224 to execute various processes, logic flows, and routines for controlling operation of the memory system 202 and/or the memory array 216.

Further, the memory system controller 214 can further include an array controller 228 that controls or oversees detailed or targeted aspects of operating the memory array 216. For example, the array controller 228 can provide a communication interface between the processor 222 and the memory array 216 (e.g., the components therein). The array controller 228 can function as a multiplexer/demultiplexer, such as for handling transport of data along serial connection to flash devices in the memory array 216.

In controlling the operations of the memory system 202, the memory system controller 214 (via, e.g., the processor 222, the embedded memory 224, and/or the array controller 228) can implement a Flash Translation Layer (FTL). The FTL can include a set of functions or operations that provide translations for the memory array 216 (e.g., the Flash devices therein). For example, the FTL can include the logical-physical address translation, such as by providing the mapping between virtual or logical addresses used by the operating system to the corresponding physical addresses that identify the Flash device and the location therein (e.g., the layer, the page, the block, the row, the column, etc.). Also, the FTL can include a garbage collection function that extracts useful data from partially filed units (e.g., memory blocks) and combines them to a smaller set of memory units. The FTL can include other functions, such as wear-leveling, bad block management, concurrency (e.g., handling concurrent events), page allocation, error correction code (e.g., error recovery), or the like.

In some embodiments, the memory system 202 can be a PCIe device. Accordingly, the host interface 212 can be configured for PCIe communications, signals, message formats, protocols, etc. Moreover, the memory controller 214 can be configured to perform PCIe features, such as the loopback mechanism 120 of FIG. 1B. For example, the memory controller 214 can issue and/or detect a loopback indicator 232 (e.g., the TS1 bit) for initiating the loopback mechanism 120. Moreover, the memory controller 214 can be configured to send, receive, detect, and/or process a loopback trigger message 234 (e.g., TS1 message) used to progress into the loopback active state 126 of FIG. 1B.

Additionally, to prevent the failure scenario illustrated in FIG. 1C, the memory controller 214 can further include a loopback control mechanism 250. The loopback mechanism 250 can be configured to identify the communication counterpart (e.g., the host 204) erroneously/unilaterally in or having entered the loopback mechanism 120 as the secondary device 104 of FIG. 1A. Moreover, upon identifying the error condition, the loopback control mechanism 250 can be configured to perform one or more response, such as logging the error condition and/or meeting the conditions required to cause the communication counterpart to reach the loopback exit state 128 of FIG. 1B.

In some embodiments, the loopback control mechanism 250 can be configured to track patterns and/or repetitions in the communications. For example, the loopback control mechanism 250 can track a recovery count 252 and/or a replay count 254. The recovery count 252 can correspond to a number of time a recovery process has been implemented. In implementing the recovery process, the communicating devices can perform a process to establish, validate, and/or retrain the communication link, such as in response to an error. For the PCIe example, the recovery count 252 can include a RX recovery count or a RX Link retrain count. The replay count 254 can correspond a number of times a data packet has been re-transmitted, such as due to an error. For the PCIe example, the replay count 254 can include a PCIe num replay counter value that has a predetermined threshold (e.g., 2048).

The loopback control mechanism 250 can use the recovery count 252 and/or the replay count 254 to detect the counterpart device (e.g., the host 204) entering the loopback mechanism 120 as the secondary device 104. Accordingly, the loopback control mechanism 250 can use the recovery count 252 and/or the replay count 254 as a trigger to implement response measures. Details regarding the detection and response are described below.

### Example Flow

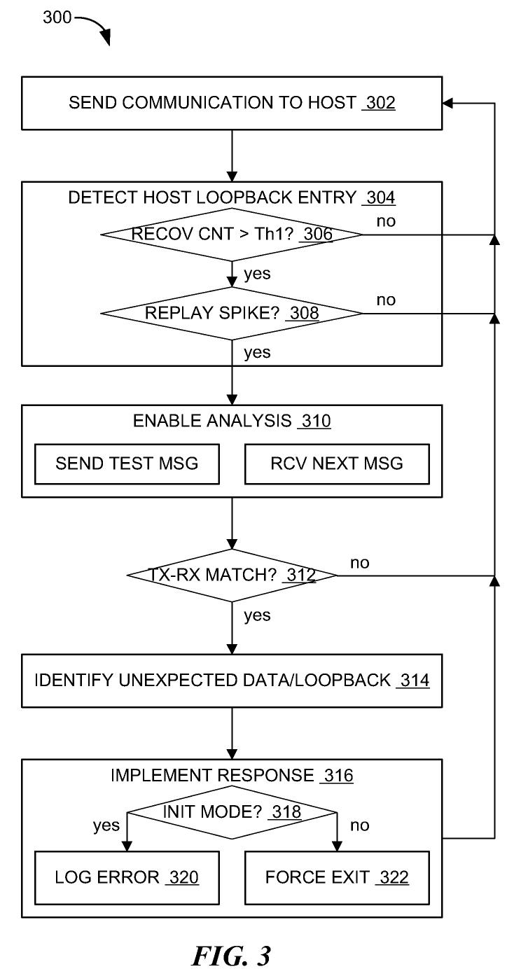

FIG. 3 is a flow diagram illustrating an example method 300 of operating an apparatus (e.g., the memory system 202 of FIG. 2, the host 204 of FIG. 2 and/or the like) in accordance with an embodiment of the present technology. The method 300 can correspond to implementing the loopback control mechanism 250 of FIG. 2 to detect and respond to unwanted entries into a loopback error scenario. When implemented at the memory system 202, the method 300 can be implemented using the hardware (e.g., the processor 222 of FIG. 2), the software (e.g., instructions in the embedded memory 224 of FIG. 2), the firmware, or a combination thereof (e.g., the FTL).

For illustrative purposes, the method 300 is described as being implemented at the memory system 202. However, it is understood that the host 204 can also have the loopback control mechanism 250 and locally implement the method 300.

At block 302, the memory system 202 can send a communication or a message to the host 204 as a part of a normal operation. For example, the memory system 202 can send the transmitted message 112 of FIG. 1A to notify the host 204 and/or as a respond to a command, such as by providing an acknowledgement (e.g., ACK/NACK) or by providing requested information (e.g., read data or housekeeping information).

Since the signal integrity issues may cause the receiving device to receive the corrupted message 114 of FIG. 1A instead of the transmitted message 112, the memory system 202 can implement the loopback control mechanism 250. In doing so, the memory system 202 can monitor various parameters to detect the host erroneously enter the loopback mode as shown in block 304. For example, the memory system 202 can monitor the recovery count 252 of FIG. 2, the replay count 254 of FIG. 2, or a combination thereof during normal operations. The memory system 202 can monitor based on detecting the targeted condition, such as the connection reestablishment process and/or the retransmission event, and incrementing a corresponding internal counter in response. The memory system 202 can check the counter according to a predetermined period/frequency.

As an illustrative example, as shown in decision block 306, the memory system 202 can determine whether the recovery count 252 exceeds a corresponding recovery threshold (e.g., a threshold value of 10-70 recovery processes). The recovery threshold can include a predetermined value/pattern representative of a sudden increase or a spike, such as a value for a session or a computing process or for a predetermine duration. When the recovery count 252 does not exceed the recovery threshold, the memory system 202 can continue normal operations as illustrated by the feedback loop to block 302. When the recovery count 252 exceeds the recovery threshold, the memory system 202 can determine whether the replay count 254 exceeds a predetermined threshold count and pattern representative of a spike, such as shown in the decision block 308. For example, the counter can track the replay count 254 for a time window leading up to the current time. Accordingly, the loopback control mechanism 250 can recognize the spike in the replay count 254 when the value exceeds the corresponding threshold (e.g., 5% - 40% or the like relative to the replay counter threshold or maximum value). When the replay count 254 does not indicate a spiking pattern, the memory system 202 can continue to operate in normal operating mode as shown by the feedback loop to block 302.

For illustrative purposes, the memory system 202 is shown analyzing the recovery counter 252 before the replay counter 254. However, it is understood that the memory system 202 can function differently using the monitored parameters. For example, the memory system 202 can analyze the replay counter 254 before the recovery counter 252. Also, the memory system 202 can analyze one of the replay counter 254 and the recovery counter 252 without the other. Moreover, the memory system 202 can analyze a different real-time connection parameter instead of or in addition to the replay counter 254 and/or the recovery counter 252.

Also for illustrative purposes, the memory system 202 is described using count values for the various triggers. However, it is understood that the triggers can be implemented differently. For example, the replay and/or the recovery thresholds can be alternatively or additionally associated with an amount of time spent in the corresponding conditions (e.g., the loopback condition). Moreover, the threshold values can be adjusted according to the implementing device (e.g., the SSD architecture), hardware limitations (e.g., buffer size), communication protocol (e.g., PCIe constraints, such as for counter sizes), and/or field data.

When the replay count 254 indicates the spiking pattern, the memory system 202 can determine an initial trigger for investigating a potential failure pattern. In other words, when the monitoring indicates an unstable connection and/or a sudden spike in the retransmissions, the loopback control mechanism 250 can essentially suspect that the communicating counterpart may have erroneously entered the loopback mode as the secondary device 104. Accordingly, the memory system 202 can enable an analysis that further investigates or tests the behavior of the host 204. Using the PCIe communication as an example, the memory system 202 can perform the analysis by sending a predetermined message uniquely unavailable to be sent by the host 204 under normal operating conditions. Given the loopback or echo portion of the loopback mechanism 120, the memory system 202 can use the predetermined message to confirm whether or not the host 204 has unintentionally and unilaterally initiated/entered the loopback mechanism 120.

Accordingly, as part of the analysis, the memory system 202 can receive a subsequent message from the host 204 to determine whether the subsequent message received from the host 204 indicates or verifies that the host 204 has initiated the loopback control mechanism 250 (e.g., on its own and without being commanded by the memory system 202). Continuing with the PCIe example, the memory system 202 can determine whether the message received from the host 204 matches the predetermined message sent prior to the received message as shown in decision block 312. When the received message does not match, that can indicate that the host 204 has not initiated the loopback mechanism. Accordingly, the memory system 202 can continue operating normally as shown by the feedback loop to block 302. Otherwise, when the received message matches the preceding sent message, the memory system 202 can confirm that the host 204 erroneously and unexpectedly entered the loopback active state and provided/has been providing unexpected data as shown in block 314.

In response to determining the erroneous state of the host 204, the memory system 202 can implement one or more responses as shown in block 316. The response may depend on the context of the operation. For example, at decision bock 318, the memory system 202 can determine whether the memory system 202 is operating under an initialization or an initial portion preceding the deployment of the memory system 202. In other words, the memory system 202 determine whether the memory system 202 is operating during system design, connection, test, debug, and/or other similar conditions associated with an administrator or a designer being involved in the overall process. When operating under such reserved and monitored conditions, the memory system 202 can determine and log the error as shown in block 320. The memory system 202 can store one or more parameters, such as the recovery count 252, the replay count 254, a recently communicated set of messages, corresponding timestamps, and/or the like. Additionally, the memory system 202 can indicate a failure or a system error. The administrator or the designer associated with the overall process can use the logged data to investigate and address the cause of the error.

When the memory system 202 is not operating in the reserved conditions, such as deployed operating conditions (e.g., after connecting/finalizing the connections for the computing system 200) the memory system 202 can take actions to remedy the situation. For example, the memory system 202 can cause the host 204 to exit the erroneous implementation of the loopback mechanism 120, such as by forcing the exit as shown in block 322. The memory system 202 can send a loopback exit command or an electrical idle exit ordered set (EIEOS) signal, thereby resetting the link and allowing the host 204 to exit and transition out of the loopback mechanism 120.

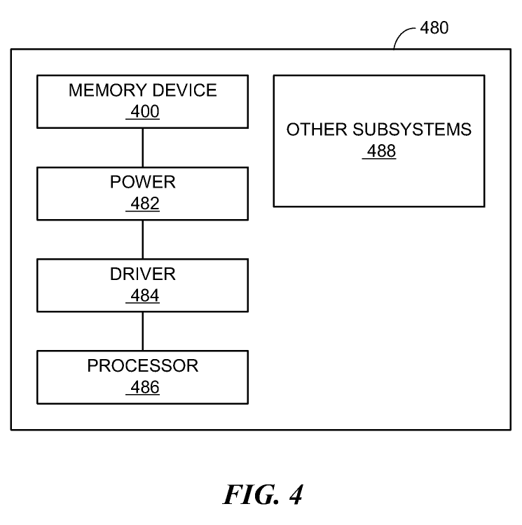

FIG. 4 is a schematic view of a system that includes an apparatus in accordance with embodiments of the present technology. Any one of the foregoing apparatuses (e.g., memory devices) described above with reference to FIGS. 1A, 1C, 2, and 3 can be incorporated into any of a myriad of larger and/or more complex systems, a representative example of which is system 480 shown schematically in FIG. 4. The system 480 can include a memory device 400, a power source 482, a driver 484, a processor 486, and/or other subsystems or components 488. The memory device 400 can include features generally similar to those of the apparatus described above with reference to one or more of the FIGS, and can therefore include various features for performing a direct read request from a host device. The resulting system 480 can perform any of a wide variety of functions, such as memory storage, data processing, and/or other suitable functions. Accordingly, representative systems 480 can include, without limitation, hand-held devices (e.g., mobile phones, tablets, digital readers, and digital audio players), computers, vehicles, appliances and other products. Components of the system 480 may be housed in a single unit or distributed over multiple, interconnected units (e.g., through a communications network). The components of the system 480 can also include remote devices and any of a wide variety of computer readable media.

From the foregoing, it will be appreciated that specific embodiments of the technology have been described herein for purposes of illustration, but that various modifications may be made without deviating from the disclosure. In addition, certain aspects of the new technology described in the context of particular embodiments may also be combined or eliminated in other embodiments. Moreover, although advantages associated with certain embodiments of the new technology have been described in the context of those embodiments, other embodiments may also exhibit such advantages and not all embodiments need necessarily exhibit such advantages to fall within the scope of the technology. Accordingly, the disclosure and associated technology can encompass other embodiments not expressly shown or described herein.

In the illustrated embodiments above, the apparatuses have been described in the context of NAND Flash devices. Apparatuses configured in accordance with other embodiments of the present technology, however, can include other types of suitable storage media in addition to or in lieu of NAND Flash devices, such as, devices incorporating NOR-based non-volatile storage media (e.g., NAND flash), magnetic storage media, phase-change storage media, ferroelectric storage media, dynamic random access memory (DRAM) devices, etc.

The term "processing" as used herein includes manipulating signals and data, such as writing or programming, reading, erasing, refreshing, adjusting or changing values, calculating results, executing instructions, assembling, transferring, and/or manipulating data structures. The term data structure includes information arranged as bits, words or code-words, blocks, files, input data, system-generated data, such as calculated or generated data, and program data. Further, the term "dynamic" as used herein describes processes, functions, actions or performance occurring during operation, usage, or deployment of a corresponding device, system or embodiment, and after or while running manufacturer's or third-party firmware. The dynamically occurring processes, functions, actions or performances can occur after or subsequent to design, manufacture, and initial testing, setup or configuration.

The above embodiments are described in sufficient detail to enable those skilled in the art to make and use the embodiments. A person skilled in the relevant art, however, will understand that the technology may have additional embodiments and that the technology may be practiced without several of the details of the embodiments described above with reference to one or more of the FIGS. described above.

We claim:

1. A computing system, comprising:
a host;
a Peripheral Component Interconnect Express (PCIe) link connected to the host; and
a memory device communicatively coupled to the host through the PCIe link, the memory device configured to:
implement a loopback mechanism with the memory device as a primary device for testing the PCIe link, wherein the loopback mechanism is initiated when the memory device sets a TS loopback bit to indicate to the host to operate as a secondary device that retransmits a message sent from the memory device;
monitor one or more parameters associated with communicating with the host, wherein the one or more parameters include a RX link retrain count, a PCIe num replay counter value, or both;
based on the monitored one or more parameters, detect that the host is erroneously functioning as the secondary device for the loopback mechanism before or without the loopback indicator is sent; and
implement a response to detecting that the host is erroneously functioning as the secondary device.

2. The computing system of claim 1, wherein the response includes storing the one or more parameters and indicating a failure for the memory device, the PCIe link, or a combination thereof.

3. The computing system of claim 1, wherein the response includes sending an electrical idle exit ordered set (EIEOS) signal to the host before or with the loopback indicator.

4. The computing system of claim 1, wherein the memory device is configured to:
initially detect that the host is erroneously functioning as the secondary device when the RX link retrain count, the PCIe num replay counter value, or both exceed corresponding thresholds;
based on the initial detection, send a test message to the host;
receive a message from the host after sending the test message; and
confirm detection that the host is erroneously functioning as the secondary device when the received response matches the test message sent to the host.

5. The computing system of claim 1, wherein the memory device is configured to detect that the host is erroneously functioning as the secondary device based on:
determining that the RX link retrain count exceeds a recovery threshold; and
when the RX link retrain count exceeds the recovery threshold, determining that the PCIe num replay counter value corresponds to a spike pattern.

6. The computing system of claim 5, wherein:
the RX link retrain count represents a number of times a data packet has been re-transmitted in response to an error;
the PCIe num replay counter value represents a number of times a data packet has been re-transmitted; and
the RX link retrain count and the PCIe num replay counter value have exceeded corresponding thresholds without a notification that the host is starting to function as the secondary device.

7. The computing system of claim 5, wherein:
the recovery threshold for the RX link retrain count is 10 or greater; and
the spike pattern corresponds to the PCIe num replay counter value exceeding at least 10% of a maximum value for the PCIe num replay counter value within a predetermined duration.

8. An apparatus, comprising:
a communication interface configured to communicatively couple the memory device to an external device; and
a memory controller coupled to the communication interface and configured to:
implement a loopback mechanism for testing a communication link between the apparatus and the external device, wherein the loopback mechanism is initiated when the memory device sends a loopback indicator for the external device to operate as a secondary device that retransmits a message sent from the memory device;
monitor one or more parameters associated with communicating with the external device;
based on the monitored one or more parameters, detect that the external device is erroneously and unilaterally implementing the loopback mechanism before or without the loopback indicator is sent; and
implement a response to detecting that the external device is erroneously functioning as the secondary device.

9. The apparatus of claim 8, wherein:
the communication interface is configured to communicatively couple the memory device to the external device for a Peripheral Component Interconnect Express (PCIe) link;
the loopback mechanism is a PCIE loopback mechanism; and
the loopback indicator is sent by setting a TS loopback indicator bit.

10. The apparatus of claim 9, wherein the monitored one or more parameters include a recovery count representative of a number of time a process for reestablishing, retraining, or confirming a communicating link between the apparatus and the external device.

11. The apparatus of claim 10, wherein the erroneous and unilateral implementation of the loopback mechanism of the external device is detected when the recovery count exceeds a threshold of 10 or more.

12. The apparatus of claim 9, wherein the monitored one or more parameters include a replay count representative of a number of retransmissions of one or more data packets communicated between the apparatus and the external device.

13. The apparatus of claim 12, wherein the erroneous and unilateral implementation of the loopback mechanism of the external device is detected when the replay count exceeds a threshold or 50 or more.

14. The apparatus of claim 13, wherein the erroneous and unilateral implementation of the loopback mechanism of the external device is detected based on determining that the replay count exceeds the corresponding threshold after determining that a recovery count exceeds a recovery threshold of 10 or more, the recovery count representing a number of time a process for reestablishing, retraining, or confirming a communicating link between the apparatus and the external device.

15. The apparatus of claim 9, wherein the erroneous and unilateral implementation of the loopback mechanism of the external device is detected based on:
initially detecting that the external device is erroneously functioning as the secondary device when the one or more parameters exceed corresponding thresholds;
based on the initial detection, sending a test message to the external device;
receiving a message from the external device after sending the test message; and
confirming that the external device is erroneously functioning as the secondary device when the received message matches the test message sent to the external device.

16. The apparatus of claim 9, wherein the implemented response includes logging the one or more parameters and sending a failure indication for the apparatus.

17. The apparatus of claim 9, wherein the implemented response includes sending a command for the external device to exit the loopback mechanism.

18. The apparatus of claim 9, wherein the apparatus is a memory device.

19. The apparatus of claim 18, wherein the memory device is a solid state drive (SSD).

20. A method of operating a memory device that includes memory cells configured to store data, the method comprising:
implementing an initial instance of a transient scan in response to a power-on event for transitioning the memory cells from a stable state to a transient state, the transient state representing a physical state of the memory cells that corresponds to a lower error rate than the stable state in providing access to the stored data,
wherein implementing the transient scan is implemented according to a variable ganging size set to a first number of blocks,
wherein implementing the transient scan includes reading from the memory cells with a ganged reset read (GRR) that reads a number of memory blocks according to the variable ganging size and without providing read results to an external circuit;
dynamically adjusting the variable ganging size to a second number of blocks, different from the first number, after initially implementing the transient scan; and
implementing a subsequent instance of the transient scan according to the second number of blocks.
